(19) United States
(12) Patent Application Publication
(10) Pub. No.: US 2014/0254842 A1
(43) Pub. Date: Sep. 11, 2014

(54) Situational Hearing Enhancement and Protection

(71) Applicant: SUREFIRE, LLC, Fountain Valley, CA (US)

(72) Inventors: Richard C. Smith, Costa Mesa, CA (US); Diann Smith, Costa Mesa, CA (US); Fred Soria, Corona, CA (US); Mark Squire, San Diego, CA (US); Joe Saggio, Anaheim Hills, CA (US)

(73) Assignee: Surefire, LLC, Fountain Valley, CA (US)

(21) Appl. No.: 13/789,006

(22) Filed: Mar. 7, 2013

(51) Int. Cl. H04R 25/00

(52) U.S. Cl. CPC H04R 25/50
USPC 381/317

(57) ABSTRACT

System and methods can provide both hearing enhancement and hearing protection. An audiogram can be determined for either an individual person or a group of people. A frequency spectrum of an environment can be determined for an environment within which hearing enhancement and/or hearing protection is needed. The audiogram and the frequency spectrum of the environment can be used to modify an electronic signal to attenuate noise and to amplify information. The information can be voice, sirens, bells, or anything else that the user desires to hear.

### TECHNICAL FIELD

One or more embodiments of the invention relate generally to acoustics and, more particularly, to hearing enhancement and protection.

### BACKGROUND

Hearing enhancement is well known. Hearing aids enhance the hearing of hearing impaired individuals by amplifying ambient sound. Amplification of the ambient sound can be performed electronically and can be based upon the frequency thereof. That is, those frequencies for which the user is most impaired can be amplified the most. In this manner, an attempt can be made to provide the user with approximately normal hearing (human perceived flat hearing) across a substantial portion of the audible frequency range. Hearing enhancement can also be performed for hunting, covert operations, battlefield operations, police work, and the like.

Hearing protection is also well known. Hearing protection devices attempt to attenuate excessive levels of ambient sound, e.g., to provide levels that have been deemed safe or at least less harmful. Attenuation of the ambient sound can be performed mechanically, by blocking sound before it reaches the ear drum. Ear muffs cover or surround the outer ear to inhibit sound from entering the ear canal. Ear plugs are inserted into the ear canal to inhibit sound from reaching the ear drum.

### SUMMARY

Methods and systems for providing hearing enhancement and/or protection are provided for one or more embodiments. Such methods and systems can be used in military, police, and civilian applications. For example, soldiers and police officers can use such systems to reduce the sound of gunfire and explosions while enhancing the ability to understand speech and to hear important sounds like those associated with furtive movements in urban environments. As a further example, hunters can use such systems to reduce the sound of gunfire while enhancing the ability to understand speech and to hear sounds like those associated with animal movements in the brush.

According to an embodiment, a device can comprise an occluding earpiece, a memory, a digital signal processor (DSP), a microphone and a speaker. The microphone can be configured to receive ambient sound containing environmental noise (undesirable and/or harmful sound) and information (important, necessary, and/or desirable sound). The memory can be configured to store a signature of the environmental noise and to store an audiogram (such as an audiogram of a person or a group of people). The digital signal processor can be configured receive a digital audio signal containing the environmental noise and the information, to attenuate the environmental noise in the digital audio signal according to the environmental noise signature, to compensate the digital audio signal for hearing loss according to the audiogram, and/or to provide a digitally processed audio signal. The digitally processed audio signal can contain enhanced information and mitigated environmental noise. The speaker can be configured to provide audio representative of the digitally processed audio signal.

According to an embodiment, a method can comprise determining an audiogram and determining a frequency spectrum of an environment. The audiogram and the frequency spectrum of the environment can be used to modify an electronic signal to attenuate noise and to amplify information.

The scope of the invention is defined by the claims, which are incorporated into this Summary by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a block diagram illustrating a device for hearing enhancement and protection, in accordance with an embodiment of the invention.

FIG. 2A shows a block diagram illustrating further detail of the device for hearing enhancement and protection, in accordance with an embodiment of the invention.

FIG. 2B shows a block diagram illustrating further detail of the device for hearing enhancement and protection, in accordance with an embodiment of the invention.

FIG. 3 shows a flow chart illustrating a method for hearing enhancement and protection, in accordance with an embodiment of the invention.

FIG. 4 shows a flow chart illustrating further detail of the method for hearing enhancement and protection, in accordance with an embodiment of the invention.

FIGS. 5A and 5B are charts related to use of the hearing enhancement and protection system by a person with substantially normal hearing, in accordance with an embodiment of the invention.

FIGS. 6A and 6B are charts related to use of the hearing enhancement and protection system by a person requiring increased mid frequency response, in accordance with an embodiment of the invention.

FIGS. 7A and 7B are charts related to use of the hearing enhancement and protection system with a substantially flat response, in accordance with an embodiment of the invention.

FIGS. 8A and 8B are charts related to use of the hearing enhancement and protection system with substantially enhanced high frequency response, in accordance with an embodiment of the invention.

Embodiments of the invention and their advantages are best understood by referring to the detailed description that follows. It should be appreciated that like reference numerals are used to identify like elements illustrated in one or more of the figures.

### DETAILED DESCRIPTION

Systems and methods can provide both hearing enhancement and hearing protection, according to embodiments. Hearing enhancement and hearing protection can be provided simultaneously. In this manner, hearing can tend to be optimized. That is, harmful and/or undesirable sounds can be mitigated, e.g., attenuated, while important, necessary, and/or desirable sounds can be enhanced, e.g., amplified.

An audiogram can be determined for either an individual person or a group of people. A frequency spectrum of an environment can be determined for an environment within which hearing enhancement and/or hearing protection is desired. The audiogram and the frequency spectrum of the environment can be used to modify an electronic signal to attenuate noise and to amplify information. The noise can be gunfire, explosions, car motors, aircraft engines, or generators, for example. The noise can be any sound that is either harmful (such as to the ear) or that is undesirable for the user to hear (such as sounds that may distract or annoy the user and such as sounds that may inhibit the user from hearing and/or understanding desired sounds). The information can be human voice, dog barking, sirens, bells, alarms, or anything else that the user desires to hear. The gain of the situation hearing enhancement and protection system can be varied on a frequency basis such that the gain is reduce for noise and increased (within predefined limits) for information.

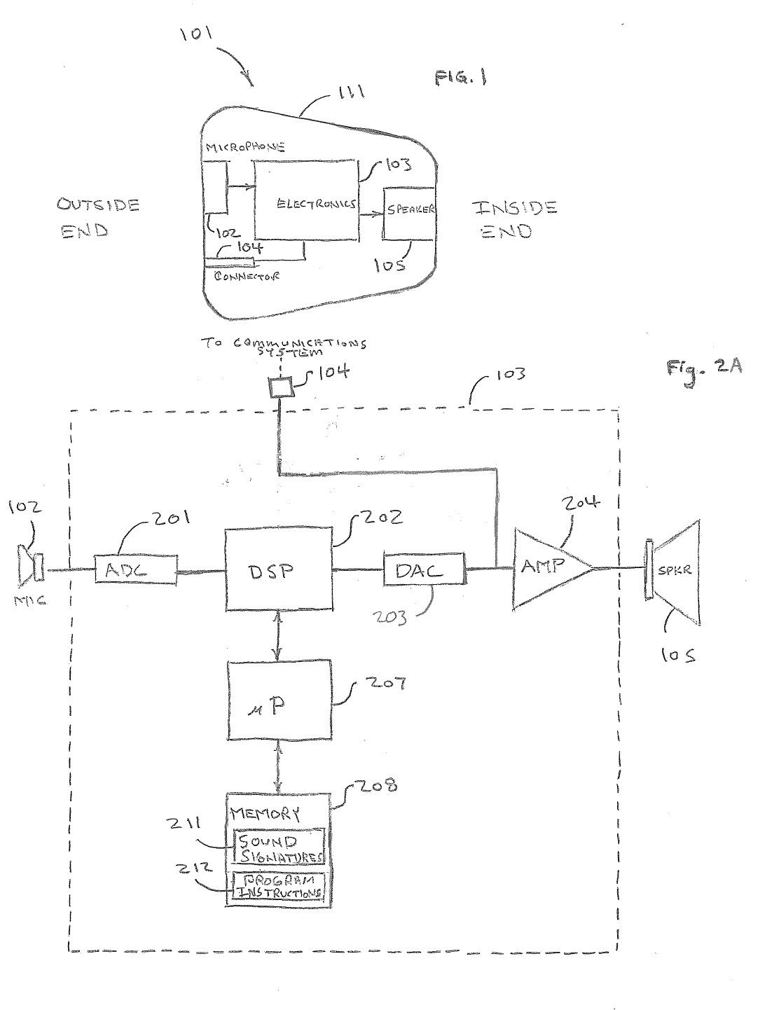

FIG. 1 shows a block diagram illustrating a device for hearing enhancement and protection, in accordance with an embodiment of the invention. A fully occluding earpiece 101 can substantially contain a microphone 102, electronics 103, a connector 104, and a speaker 105. The microphone 102 can pick up ambient sound and can transduce the sound into a signal, such as an analog electronic signal. The signal can be provided to the electronics 103. The electronics 103 can process the signal and provide a processed signal to the speaker 105. The speaker 105 can transduce the processed electronic signal to provide sound to the user's eardrum. The connector 104 can be used to input an external signal, such as from a radio.

The fully occluding earpiece 101 can define an earplug. The fully occluding earpiece 101 can substantially mitigate the communication of environment sound to the user's eardrum. Thus, fully occluding earpiece 101 can mechanically or passively provide desirable hearing protection. Additionally, the fully occluding earpiece 101 can electronically provide desirable hearing protection, as discussed herein.

The fully occluding earpiece 101 can be watertight and/or airtight. In this manner, the electronics 103 and other items disposed within the fully occluding earpiece 101 can be protected from moisture, ear wax, and other contaminants that might interfere with the proper operation of the system for environmental hearing enhancement and protection.

The fully occluding earpiece 101 can include a housing or shell 111 that is configured to fit in a human ear canal. The shell 111 can be formed of a biocompatible material. The shell 111 can be custom fit to a particular user's ear canal. The shell 111 can comprise a hard plastic material, such as polyurethane or acrylonitrile butadiene styrene (ABS). The shell 111 can comprise a soft, compliant material such as silicone. The shell 111 can comprise a hard plastic material covered with a soft, compliant material.

The fully occluding earpiece 101 can include a housing or shell 111 that is configured to fit in an animal, e.g., non-human, ear canal. For example, the fully occluding earpiece 101 can include a housing or shell 111 that is configured to fit in a canine ear canal. Thus, for example, the situational hearing enhancement and protection system can be used for K9 applications. Such use may be particularly helpful due to the more sensitive hearing of dogs. Sounds that would tend to distract the dog or interfere with desired hearing by the dog can be attenuated. Desired sounds can be amplified, as necessary. Thus, when use by or configuration for a human is discussed herein, such discussion can generally also apply to animals, such as K9 dogs.

More than one microphone 102 can be used. Each microphone 102 can be comparatively more sensitive to a different portion of the audio spectrum. Thus, a plurality of different microphones 102 can provide desired sensitivity to substantially all or to some desired portion(s) of the audio spectrum.

One or more microphones 102 can be sensitive to one or more portions of the audio spectrum that are considered to be outside of the audible range. For example, one microphone 102 can be sensitive to infrasound (such as sound having a frequency less than 20 Hz) and another microphone 102 can be sensitive to ultrasound (such as sound having a frequency greater than 20 kHz). Such sounds outside of the audible range can be converted to the audible range for enhanced hearing. Thus, infrasound can be up converted in frequency and ultrasound can be down converted in frequency to facilitate processing and/or human hearing.

The situation hearing and enhancement system can alert the user to otherwise inaudible sounds. Such sounds can be inaudible due to their frequency content and/or amplitude. Such inaudible sounds can be reproduced at an increased amplitude and/or different frequency so that they can be heard by the user. Such inaudible sounds can be replaced with other sounds, such as a warning, voice identification or other identification. For example, an inaudible sound that is characterized as a handgun being cocked can result in a voice notification that such a sound has been identified or can result in a distinctive siren or other indication.

Such inaudible sounds or sound signatures representative thereof can be stored in a database (such as in the manner of environmental signatures). Thus, either frequency signatures (Fourier transform data) or the sounds themselves (waveforms) can be stored in the database.

Then, subsequently received inaudible sounds or their sound signatures can be compared to the sounds or sound signatures stored in the database. When a match is determined, the appropriate indication can be provided to the user.

The fully occluding earpiece 101 can be configured to fit at least partially within a user's ear canal. For example, the fully occluding earpiece 101 can be configured to fit entirely with the user's ear canal. A portion of the fully occluding earpiece can extend from the user's ear canal.

A portion of the fully occluding earpiece can be dispose remotely upon the user with respect to the user's ear canal. For example, the electronics 103 can be worn on the user's belt.

A portion of the electronics can be disposed remotely with respect to the user. For example, digital processing of the signal can be performed on a computer that is located many miles away from the user. Communications between the local electronics 103 and any remote electronics can accomplished be via a network, such as a cellular telephone network, a satellite network, and/or a computer network (such as the Internet). Processing by the remote electronics can occur substantially in real time.

The fully occluding earpiece 101 can be configured to fully occlude the ear canal and thus substantially attenuate environmental sound entering the ear and traveling toward the user's eardrum. The fully occluding earpiece 101 can be watertight and/or airtight with respect to the ear canal. Thus, the fully occluding earpiece 101 can inhibit sound, water, dirt, and the like from undesirable entering the ear canal. It is not necessary that the fully occluding earpiece 101 be watertight and/or airtight with respect to the ear canal.

According to an embodiment, the microphone 102, the electronics 103, the connector 104, and/or the speaker 105, as well as a battery, can all be disposed within the fully occluding earpiece 101. Thus, the situational hearing enhancement and protection device can be autonomous or fully self-contained.

According to an embodiment, the microphone 102, the electronics 103, the connector 104, and/or the speaker 105 can be disposed outside or partially outside of the fully occluding earpiece 101. Thus, at least some of the microphone 102, the electronics 103, the connector 104, and/or the speaker 105 can be located remotely with respect to the fully occluding earpiece 101. For example, the microphone 102, the electronics 103, and/or the connector 104 can be located outside of the fully occluding earpiece 101 and can be disposed within a separate housing that is part of a cable assembly and/or is attached to the clothing (such as the belt).

The fully occluding earpiece 101 can receive sound signals wirelessly from microphones that are not part of the fully occluding earpiece 101 and that are not located upon the user. Such microphones can be located remotely with respect to the user. For example, the fully occluding earpiece 101 can contain a radio receiver for receiving two-way radio communications and/or for receiving a signal from surveillance microphones.

Two occluding earpieces 101 can be used to provide binaural hearing, such as for the localization of sound sources. Two microphones 102 can be locate on the user to better facilitate or exaggerate binaural hearing. For example, one microphone 102 can be attached to the user's belt on the left side of the user and can provide a signal to the occluding earpiece 101 for the left ear and another microphone 102 can be attached to the user's belt on the right side of the user and can provide a signal to the occluding earpiece 101 for the right ear. Such enhance binaural hearing can better facilitate localization of sound sources.

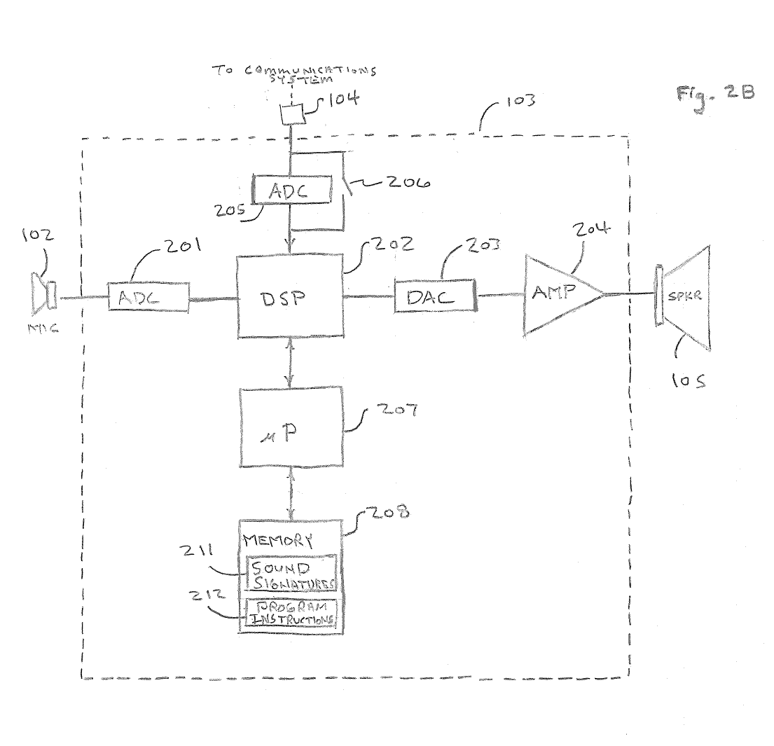

FIG. 2A shows a block diagram illustrating further detail of the device for hearing enhancement and protection, in accordance with an embodiment of the invention. The electronics 103 can comprise an analog-to-digital convertor (ADC) 201, a digital signal processor (DSP) 202, a digital-to-analog converter (DAC) 203, an amplifier 204, a microprocessor (pP) 207, and a memory 208. The microprocessor 207 can include an application specific integrated circuit (ASIC), a microcontroller unit (MCU) and/or a programmable intelligent computer (PIC) such as that manufactured by Microchip Technology Inc. of Chandler, Ariz.

The analog-to-digital convertor 201 can receive an analog electronic signal from the microphone 102 and can provide a digital electronic signal to the digital signal processor 202. The digital signal processor 202 can perform digital signal processing upon the digital electronic signal and can provide a processed digital electronic signal to the digital-to-analog convertor 203. The digital signal processing can include filtering, attenuation, and/or compression of noise as well as amplification of information, as discussed herein.

The digital-to-analog convertor 203 can convert the processed digital electronic signal into a processed analog electronic signal and can provide the processed analog electronic signal to the amplifier 204. The amplifier 204 can amplify the analog electronic signal to a level suitable for listening to after the analog electronic signal has been transduced into sound by the speaker 105.

The memory 208 can be in communication with the microprocessor processor 207 and can store sound signatures 211 and/or program instructions 212. The memory 208 can store any desired information. The memory 208 can be in communication with the digital signal processor 202, either directly or via the microprocessor 207. The memory 208 can be a random access memory (RAM), read only memory (ROM), or any other type of memory. The use of a random access memory can facilitate dynamic, real-time acquisition and processing of sound signatures. The use of a read only memory can facilitate the use of pre-defined sound signatures. The memory 208 can contain firmware for operating the digital signal processor 202. The program instructions can be executed by any combination of hardware, software, and firmware.

The sound signatures 211 can include sound signatures of undesirable sounds that are to be mitigated. The sound signatures can be predefined or obtained substantially in real time.

The sound signatures can include frequency information regarding the undesirable sounds. For example, the sound signatures can include Fourier transforms of the undesirable sounds. The frequency information can be used by the digital signal processor to attenuate the undesirable sounds. The sound signatures can include waveforms of the undesirable sounds. The waveforms can be used by the digital signal processor to attenuate the undesirable sounds.

The sound signatures 211 can include sound signatures of desirable sounds that are to be enhanced. The sound signatures can include frequency information regarding the desirable sounds. For example, the sound signatures can include Fourier transforms of desirable sounds. The frequency information can be used by the digital signal processor to increase the level of the desirable sounds. The sound signatures can include waveforms of the desirable sounds. The waveforms can be used by the digital signal processor to amplify the desirable sounds.

The program instructions 212 can facilitate operation of the situational hearing enhancement and protection system. For example, the program instructions 212 can include algorithms for use by the digital signal processor 202 to enhance desired sounds and to mitigate undesired sounds. In accordance with embodiments, various conventional algorithms can be used by the digital signal processor 202, as would be understood by one of ordinary skill in the art.

The desired sounds can be enhanced by amplification, regenerative feedback, or any other desired method. The undesired sounds can be mitigated by compression, filtering, degenerative feedback, noise cancellation (such as be creating a complimentary, out-of-phase signal that is combined with the noise signal to effect cancellation), or by any other method. The desired sounds can be enhanced by mitigating the undesired sounds and then amplifying the resulting signal.

Low level desirable sounds, e.g., information, can be replaced with artificial sounds. For example, when the signal-to-noise level is too high to facilitate sufficient amplification, low level desirable sounds can be substantially removed and artificial sounds representative thereof can be added in their place. Such artificial sounds can be similar, e.g., can sound like, the sounds they are replacing or can be substantially different with respect thereto.

The digital signal processor 202 can be a general purpose processor (such as the microprocessor 207) that is configured to perform digital signal processing functions. The digital signal processor 202 can be a dedicated digital signal processor.

The digital signal processor 202 can apply digital filtering to remove undesirable frequency components from sound received by the microphone 102. Thus, such undesirable sound can be attenuated before the sound is reproduced by the speaker 105.

The digital signal processor 202 can facilitate analysis of sound received by the microphone 102. For example, the microprocessor 202 and/or the digital signal processor 202 can execute a discrete Fourier transform (DFT) or a fast Fourier transform (FFT) algorithm stored as program instructions 212 in the memory 208. The digital signal processor 202 can include a hardware design that is optimized and/or dedicated to the performance of digital filtering and/or FFT performance.

The digital signal processor 202 can be a separate, dedicated digital signal processor. The digital signal processor 202 can include or can be the microprocessor 207. Thus, digital signal processing functions can be performed by a general purpose microprocessor, for example.

FIG. 2B shows a block diagram illustrating further detail of the device for hearing enhancement and protection, in accordance with an embodiment of the invention. The device can include an analog-to-digital-converter 205 and a switch 206.

The analog-to-digital converter 205 can convert an analog communications signal, such as from a radio, into a digital communications signal for processing by the digital signal processor 202. The digital signal processor 202 can enhance the digital communications signal as well as the microphone signal, as discussed herein.

A switch 206 can bypass the analog-to-digital convertor 205, such as to facilitate communication of a digital communications signal to the digital signal processor 202 without analog-to-digital conversion. Thus, the analog-to-digital convertor 205 can be used when needed (such as when the communications signal is analog) and can be omitted when not needed (such as when the communications signal is digital).

The digital signal processor 202 can process the communications signal, as desired. For example, the digital signal processor 202 can vary the volume of the communications signal and/or can filter or shape the frequency spectrum of the communications signal. Thus, the digital signal processor 202 can enhance the communications signal by increasing frequencies that better facilitate desired communications and by mitigating noise.

The digital signal processor 202 can mix other signals with the communications signal. For example, the digital signal processor 202 can mix ambient sound with the communications signal. The ambient sound can be filtered so that only voice is substantially mixed with the communications signal.

The digital signal processor 202 can pass the communications signal therethrough substantially unaltered. For example, a digital communications signal can pass through the digital signal processor 202 without substantial alteration when the digital communications signal is present and an ambient signal can be processed by the digital signal processor 202 when no digital communications signal is present.

The components of the situational hearing protection and enhancement device can be either collocated, distributed, or some combination of collocated and distributed. Thus, the components do not necessarily have to be in the shell 111. Rather, some components can be in the shell 111 and other components can be worn on a belt clip, for example.

As a further example, a battery can be located either within the shell 111 or outside of the shell 111. The battery can be outside of the ear, such as behind the ear or on a belt clip, for example.

As yet a further example, the microphone 102, the digital signal processor 202, the amplifier 204, and the speaker 105 can be in the shell ill, while the microprocessor 207, a push-to-talk switch (not shown), an input port 104, and the battery are not in the shell 111. The microprocessor 207, the push-to-talk switch, the input port 104, and the battery can be in a body-worn housing, for example.

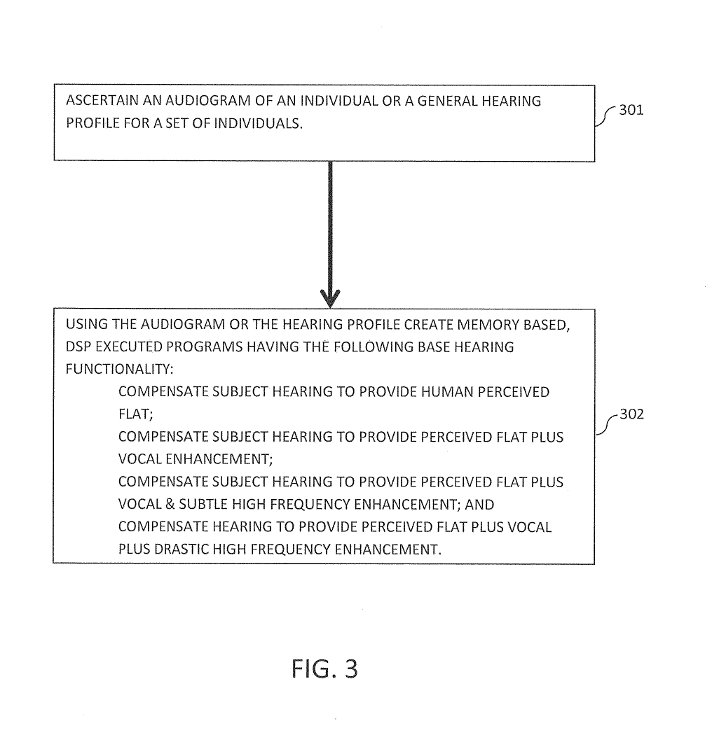

FIG. 3 shows a flow chart illustrating a method for hearing enhancement and protection, in accordance with an embodiment of the invention. An audiogram of an individual or a general hearing profile for a set of individuals can be ascertained, as shown in step 301.

The audiogram can be for an individual person. That is, the audiogram can be an audiogram acquired by performing a hearing test on the person who is to use the system. In this manner, the system can be custom tailored for a specific user.

The general hearing profile can be an audiogram for a group of people. For example, the general hearing profile can be an average of audiograms for a group of people. Different general hearing profiles can be used for different age groups of users. Different general hearing profiles can be used for men and women. Different general hearing profiles can be used for different environments. Thus, the hearing profile can depend upon particulars of the individual (such as age and gender), as well as upon particulars of the environment (such as the noise character thereof).

Rather than an average, the general hearing profile can be configured so as to compensate for the worst hearing of the group. That is, the general hearing profile can reflect the worst hearing of the individuals of the group on a frequency band-by-frequency band basis. Thus, the general hearing profile can be a worst case audiogram. The general hearing profile can be any combination of an average and worst case audiogram.

The general hearing profile can be an exponential group audiogram that expresses outliers (frequency bands where extreme hearing loss is exhibited by only a few individuals) substantially less than more average hearing loss (such as the hearing loss exhibited by more individuals).

The general hearing profile can be a synthetic audiogram. The synthetic audiogram can be configured so as to reflect typical or other hearing loss. The synthetic audiogram can be configured so as to result in any desired hearing enhancement and/or protection. For example, the synthetic audiogram can be configured so as to result in hearing enhancement in extremely high frequencies, in extremely low frequencies, and/or in any desired bands of frequencies. The synthetic audiogram can be configured to enhance hearing in some desired frequency ranges and to mitigate sound in other, undesired frequency ranges.

Synthetic audiograms can be configured for specific environments and/or for specific users. Thus, audiograms can be made that provide desired hearing enhancement and/or hearing protection based upon expected noise exposures and/or based upon expect user characteristics. For example, if excessive noise is expected in a frequency band of 3120 Hz to 3130 Hz, then a synthetic audiogram can be used that results in this band can being heavily filtered and the remaining voice band of 400 Hz to 4,000 Hz being amplified.

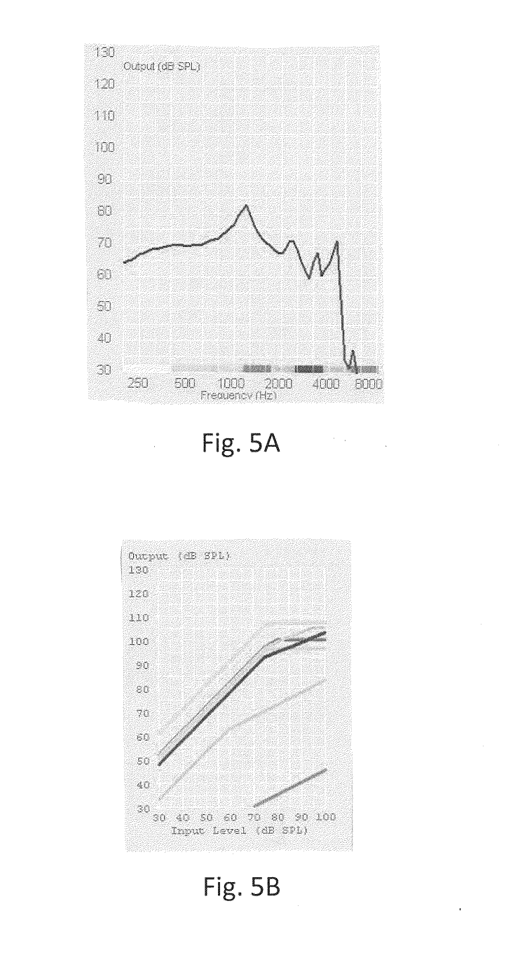

Memory based, digital signal processing programs can be created using the audiogram or the general hearing profile, as shown in step 302. Each of the programs can have different modes or presets for base hearing functionality. One program can compensate user hearing to provide human perceived flat hearing. Thus, substantially normal hearing can be provided. For example, the program can tend to compensate for hearing loss of the user. An example of a display of a configuration screen for the hearing enhancement and protection system for providing perceived flat hearing is shown in FIG. 5.

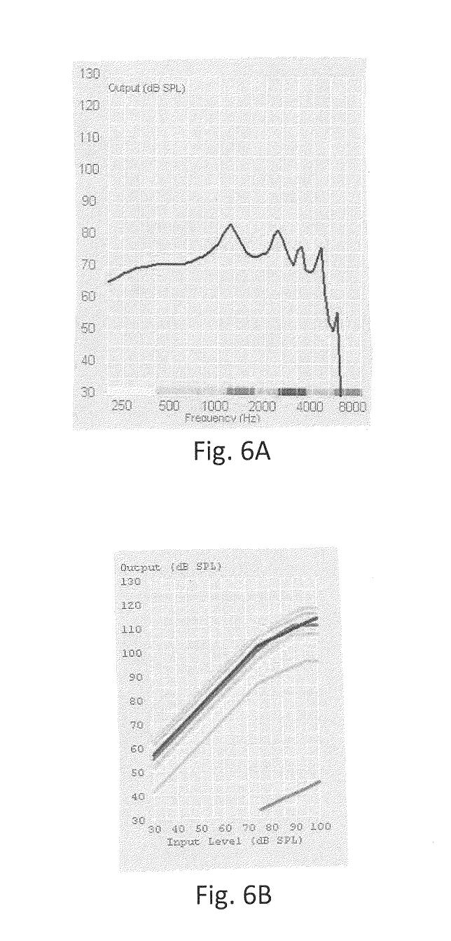

Another program can compensate user hearing to provide human perceived flat plus vocal enhancement. For example, the program can tend to compensate for hearing loss of the user while also enhancing frequencies within the vocal range, e.g., 400 Hz to 4,000 Hz. An example of a display of a configuration screen for the hearing enhancement and protection system for providing perceived flat hearing plus vocal enhancement is shown in FIG. 6.

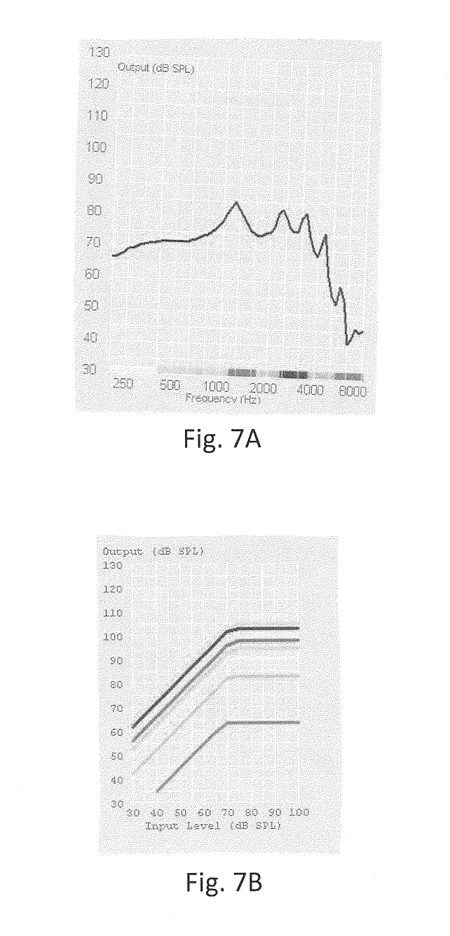

Another program can compensate user hearing to provide human perceived flat plus vocal enhancement, plus subtle high frequency enhancement. For example, the program can tend to compensate for hearing loss of the user while also enhancing frequencies within the vocal range, e.g., 400 Hz to 4,000 Hz, and while also subtly enhancing frequencies above 10,000 Hz. An example of a display of a configuration screen for the hearing enhancement and protection system for providing perceived flat hearing plus vocal enhancement, plus subtle high frequency enhancement, is shown in FIG. 7. Subtle high frequency enhancement can be enhancement by less than 3 dB.

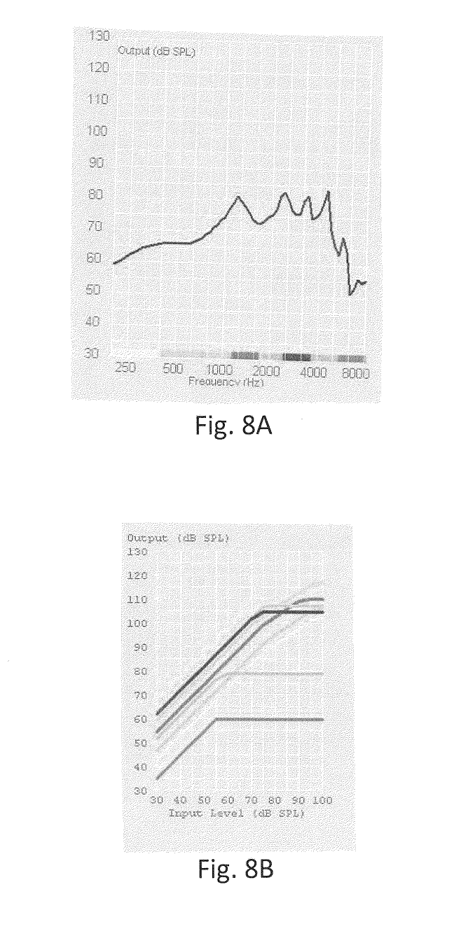

Another program can compensate hearing to provide human perceived flat plus vocal, plus drastic high frequency enhancement. For example, the program can tend to compensate for hearing loss of the user while also enhancing frequencies within the vocal range, e.g., 400 Hz to 4,000 Hz, and while also drastic, e.g., more than subtle, enhancing frequencies above 10,000 Hz. An example of a display of a configuration screen for the hearing enhancement and protection system for providing perceived flat hearing plus vocal enhancement, plus drastic high frequency enhancement is shown in FIG. 8. Drastic high frequency enhancement can be enhancement by more than 3 dB.

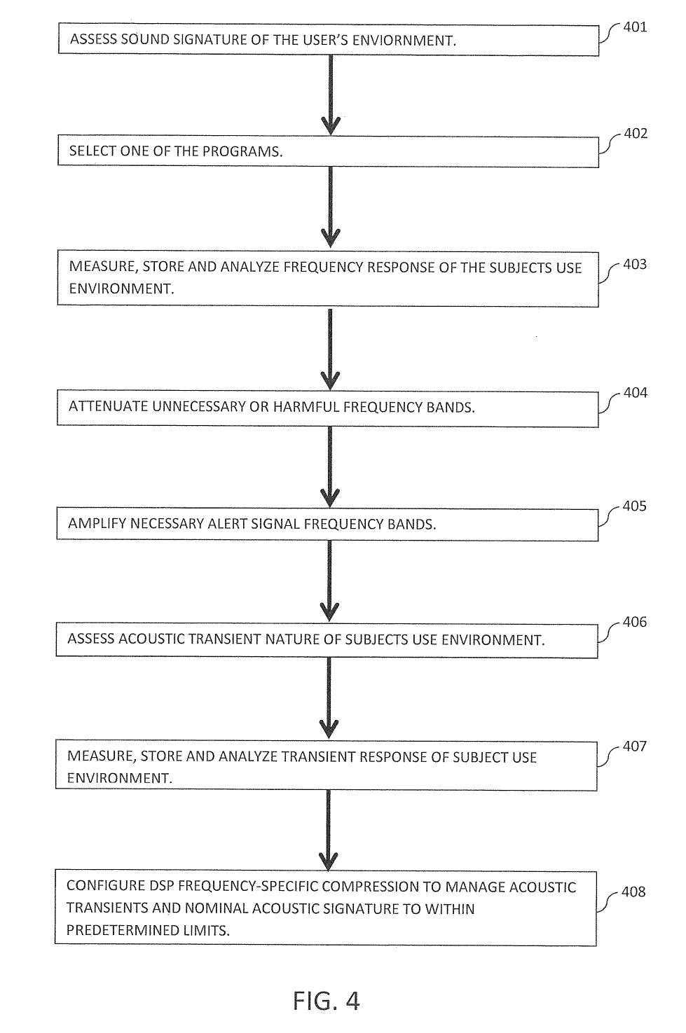

FIG. 4 shows a flow chart illustrating further detail of a method for hearing enhancement and protection, in accordance with an embodiment of the invention. A sound signature of the user's environment can be accessed, as shown in step 401. The sound signature can be accessed, at least in part, using the situational hearing enhancement and protection device 101 or using any other device. Thus, the sound signature need not be accessed completely in real time or completely via the situational hearing enhancement and protection device 101. Alternatively, the sound signature can be accessed, at least in part, in real time or, at least in part, via the situational hearing enhancement and protection device 101.

The user can select one of the programs, as shown in step 402. The desired program can be selected in a shop during a setup process, such as by either the user or a technician. The desired program can be selected in the field by the user. Thus, the user can select a program that is best suited for the situation, e.g., the acoustic environment.

The situational hearing enhancement and protection device 101 can measure, store and analyze a frequency response of the users use environment, as shown in step 403. In this manner, the acoustic environment of the user can be characterized.

The situational hearing enhancement and protection device 101 can attenuate or compress unnecessary or harmful frequency bands, as shown in step 404. Thus, hearing protection can be provided. Further, sounds that would interfere with desirable sounds, e.g., information, can be mitigated so as to make the desirable sounds more easily heard.

Desirable and/or necessary sounds, such as those of alert signal frequency bands, can be amplified, as shown in step 405. Thus, such sounds can be more readily heard and understood.

The acoustic transient nature of users use environment can be accessed, as shown in step 406. In this manner, transient sounds can be characterized. Undesirable transient sounds can be attenuated. Desirable transient sounds can be amplified.

Undesirable sounds can be attenuated in an exponential-like fashion. That is, higher level undesirable sounds can be attenuated much more that lower level undesirable sounds. For example, undesirable sounds above 100 dB can be attenuated by 30 dB while undesirable sounds below 100 dB can be attenuated by 20 dB. Undesirable sounds can be attenuated by a fixed level, such as 25 dB. Undesirable sounds can attenuated to a desired level, such as 65 dB.

Desirable sounds can be amplified in an exponential-like fashion. That is, lower level desirable sounds can be amplified much more that higher level desirable sounds. For example, desirable sounds below 60 dB can be amplified by 12 dB while desirable sounds above 60 dB can be amplified by 6 dB. Desirable sounds can be amplified by a fixed level, such as 12 dB. Desirable sounds can amplified to a desired level, such as 72 dB.

The transient response of the user's environment can be measured, stored, and analyzed, as shown in step 407. Thus, the digital signal processor 202 can modify the environment acoustic information provided thereto in a manner that enhances situational hearing while simultaneously providing hearing protection.

Digital signal processing frequency-specific compression can be configured to manage acoustic transients and nominal acoustic signature to within predetermined limits, as shown in step 408.

According to an embodiment, a user can select which types of noise are to be attenuated and the level of attenuation. For example, the user can select to attenuate gunshot noise by 12 dB, dog barking by 6 dB, and car noise by 3 dB. Such selection can be preset, such as in a shop environment, or can be performed substantially real time, such as in the field. Thus, noise which needs to be mitigated for hearing protection can be maintained at a desired level when the noise may also be information.

Noise can be captured real time and further occurrences of the same noise can be attenuated to a desired level. Thus, the user can at least partially define the environment noise signature substantially in real time. A Fourier transform or waveform of the noise can be used to define the noise signature and the noise signature can be used to identify subsequent noise that is to be mitigated.

Information can be captured in real time and further occurrences of the same information can be amplified to a desired level. Thus, the user can at least partially define an information signature substantially in real time. A Fourier transform or waveform of the information can be used to define the information signature and the information signature can be used to identify subsequent information that is to be amplified.

According to an embodiment, a user can select which types of information are to be amplified and the level of amplification. For example, the user can select to amplify low level human voice (such as below 50 dB) by 18 dB, high level human voice (such as above 50 dB) by 9 dB, noise associated with furtive movements by 6 dB, and non-shooting gun noises (such as loading and cocking noises) by 3 dB. Such selection can be preset, such as in a shop environment, or can be performed substantially real time, such as in the field. Information can be captured real time and further occurrences of the same information can be amplified by a desired amount. Thus, the user can at least partially define the environment noise signature substantially in real time.

All or some portion of the sound received by the situation hearing enhancement and protection system during use can be stored, such as for later analysis. The sound received by the situation hearing enhancement and protection system can be stored in the memory 208 or in any other memory.

The stored sound can be downloaded, such as into a computer for analysis. For example, the user can identify noise and information within the downloaded sound so that such noise and information can be better identified and attenuated or amplified during subsequent use of the situation hearing enhancement and protection system.

Adjustments or fine tuning to the situation hearing enhancement and protection system can be performed substantially in real time. Such adjustments can be made via controls located on the occluding earpiece 101 or located elsewhere. For example, the occluding earpiece 101 can communicate to a hand held or belt worn device to facilitate such adjustment. Communication with the hand held or belt worn device can be via a wired connection or via a wireless connection. Communication with the hand held or belt worn device can be via Bluetooth, WiFi, or any other system or protocol. The hand held or belt worn device can be a smart cellular telephone, such as an iPhone. Thus, the situation hearing enhancement and protection system can be controlled and/or adjusted via an app running on a cellular telephone.

Such adjustment can include tuning frequencies or frequencies bands to be attenuated and/or amplified. Such adjustment can include identifying sounds or types of sounds to be attenuated and/or amplified. The sounds can be natural sounds, such as those made by an animal. The sounds can be artificial sounds, such as those made by a device, machine, gun, motor, or engine.

FIGS. 5A-8B are examples of charts that show various different ways that the digital signal processor 202 of the situational hearing enhancement and protection system can operate. Other such charts can similarly be used. Other such charts can be specific to the hearing capability (e.g., the hearing loss) of the user, the user's needs (such as to understand speech), and/or the user's environment.

For example, a number of such charts (such as 2, 4, 8, 16, 32, 64, 128, or more) can be preprogramed into the situational hearing enhancement and protection system. The user can then select when chart to use. That is, the user can select which chart is best suited to the user and/or the user's environment at any given time. Such selection can be performed substantially in real time, such as to accommodate changes in the user's needs or the environment.

FIGS. 5A and 5B are examples of charts related to use of the hearing enhancement and protection system by a person with substantially normal hearing, in accordance with an embodiment of the invention. FIG. 5A shows an example of a frequency response or frequency equalization curve that can be used to at least partially overcome limitations associated with the speaker 105 (or any other component or combination of components of the system) to provide a more optimal response to the user's eardrum at voice frequencies. Thus, those frequencies that are less well reproduced by the speaker 105 can better emphasized (amplified) while those frequencies that are more than adequately reproduced by the speaker 105 can be de-emphasized (attenuated).

FIG. 5B shows examples of compression curves that are suitable for use with the response curve of FIG. 5A. Such compression curves show how sounds of a give input level can be amplified or attenuate to a more desirable output level. In addition to providing the frequency response of FIG. 5A, the digital signal processor 202 can limit the output of the hearing enhancement and protection system using compression. Compression can be used instead of limiting at a fixed threshold, which would undesirably generate substantial harmonic distortion.

The digital signal processor 202 can be programmed with gain vs. amplitude curves as a function of frequency within a particular frequency band, as shown in FIGS. 5A, 6A, 7A, and 8A. When the signal amplitude reaches the “knee” in these charts, the gain can be slowly reduced to prevent damaging amplitudes from reaching the user's eardrum. Compression can be programmable (such as at each frequency band) for the amplitude at which compression begins (such as at the knee), the desired slope of the compression gain reduction, and the desired maximum amplitude limit allowed to pass through the system. In this manner, the user can be better protected from hearing damage.

FIGS. 6A and 6B are examples of charts related to use of the hearing enhancement and protection system by a person requiring increased mid frequency response, in accordance with an embodiment of the invention. The increased mid frequency response can make speech more easily understandable for users with typical mild hearing loss. Thus, FIG. 6A shows an example of a frequency response or frequency equalization curve that can be used by a person requiring increased mid frequency response.

FIG. 6B shows examples of compression curves that are suitable for use with the response curve of FIG. 6A. Such compression curves show how sounds of a given input level can be amplified or attenuated to a more desirable output level. In addition to providing the frequency response of FIG. 6A, the digital signal processor 202 can limit the output of the hearing enhancement and protection system using compression.

FIGS. 7A and 7B are examples of charts related to use of the hearing enhancement and protection system with a substantially flat response, in accordance with an embodiment of the invention. The substantially flat response can be used to demonstrate the actual response of the microphone 102 and the speaker 105 of the fully occluding earpiece 101. Additionally, some users may prefer the brightness that the substantially flat response curve provides. Thus, FIG. 7A shows an example of a frequency response or frequency equalization curve that can be used to demonstrate the actual response of the microphone 102 and the speaker 105 of the fully occluding earpiece 101.

FIG. 7B shows examples of compression curves that are suitable for use with the response curve of FIG. 7A. Such compression curves show how sounds of a give input level can be amplified or attenuate to a more desirable output level. Thus, in addition to providing the frequency response of FIG. 7A, the digital signal processor 202 can limit the output of the hearing enhancement and protection system using compression.

FIGS. 8A and 8B are examples of charts related to use of the hearing enhancement and protection system with substantially enhanced high frequency response, in accordance with an embodiment of the invention. The substantially enhanced high frequency response can make speech easier to understand for users with moderate to severe hearing loss. Thus, FIG. 8A shows an example of a frequency response or frequency equalization curve that can be used to enhanced high frequency response for users having high frequency hearing loss.

FIG. 8B shows examples of compression curves that are suitable for use with the response curve of FIG. 8A. Such compression curves show how sounds of a give input level can be amplified or attenuate to a more desirable output level. In addition to providing the frequency response of FIG. 8A, the digital signal processor 202 can limit the output of the hearing enhancement and protection system using compression.

The frequency response or equalization curves of FIGS. 5A, 6A, 7A, and 8A show how the acoustic input signal, e.g., ambient sound, can be modified (e.g., they show the frequency response of the situational hearing enhancement and protection system) by the digital signal processor 202 for each particular example. The output that the user's ear will hear is effectively the convolution of this curve with the response of the microphone and the speaker.

According to an embodiment, a device can comprise the occluding earpiece 101, the memory 208, the digital signal processor 202, and the speaker 105. The memory 208 can be configured to store one or more environmental noise signatures and one or more audiograms. For example, an audiogram for a single person or for a group of people can be stored, as discussed further herein.

The digital signal processor 202 can be configured receive a digital audio signal containing environmental noise, to attenuate the environmental noise in the digital audio signal according to the environmental noise signature, to compensate the digital audio signal for hearing loss according to the audiogram, and to provide a digitally processed audio signal. The speaker 105 can be configured to provide audio representative of the digitally processed audio signal.

Noise can be identified as sounds having predefined characteristics. For example, the noise can be identified as sounds having predefined frequencies, amplitudes, or durations. Samples of noise, e.g., gunshot sounds, can be characterized and used to identify noise in a user's environment.

Information can be identified as sounds having predefined characteristics. For example, the information can be identified as sounds having predefined frequencies, amplitudes, or durations. Samples of information, e.g., human voice, bells, and sirens, can be characterized and used to identify noise in a user's environment.

The microphone 102 can be configured to receive ambient sound containing the environmental noise and to provide an analog microphone signal representative thereof. The analog-to-digital converter 201 can be configured to receive the analog microphone signal, convert the analog microphone signal into a digital audio signal representative thereof, and provide the digital audio signal to the digital signal processor 202.

The digital-to-analog converter 203 can be configured to receive the digitally processed audio signal and to convert the digitally processed audio signal into a processed analog signal representative thereof. The amplifier 204 can be configured to receive the processed analog signal, to amplify the processed analog signal, and to provide an amplified analog signal. The speaker 105 can be configured to receive the amplified analog signal and to provide sound representative thereof.

The digital signal processor 202 can be configured perform Fourier analysis on the digital audio signal to facilitate a determination of an environmental noise frequency content thereof. For example, the digital signal processor 202 can be configured perform a fast Fourier transform (FFT) on the digital audio signal to facilitate a determination of an environmental noise frequency content thereof.

The digital signal processor 202 can be configured subtract frequencies that are present in the environmental noise from the digital audio signal. The digital signal processor 202 can be configured to increase a level of the digital audio signal for frequencies where hearing loss is present, according to the audiogram. Thus, the digital signal processor 202 can provide a desired hearing response for the user. For example, the digital signal processor 202 can provide a substantially flat hearing response, a substantially flat hearing response with vocal enhancement, a substantially flat hearing response with vocal enhancement and subtle high frequency enhancement, or a substantially flat hearing response with vocal enhancement and drastic high frequency enhancement. The digital signal processor 202 can provide any desired hearing response.

The desired hearing response can depend upon the user, the environment, and the application. The desired hearing response for a soldier on a noisy battlefield can be different from the desired hearing response for a police officer searching a quiet home for a potentially armed suspect. The soldier can have frequencies associated with gunfire and explosions attenuated and can frequencies associated with voice commands enhanced.

The police officer can have hearing loss at least partially compensated for and can have frequencies associated with firearm use (other than firing of the firearm) enhanced. For example, the police officer can have frequencies associated with cocking a firearm, moving a safety of a firearm from on to off, loading a firearm, and the like amplified.

The input port 104 can receive a signal from a communications system, such as a portable two-way radio, and can provide the signal from the communications system to the digital signal processor 202. The input port 104 can be a jack for receiving a plug from a radio cable, for example. Thus, radio communication can be listened to while hearing protection is provided and ambient voice communication is enhanced. The digital signal processor 202 can attenuate noise in the signal from the communications system and can also modify the signal from the communications system to compensate for hearing loss.

The digital signal processor can be configured to increase a level of the digital audio signal for frequencies that contain non-verbal information. The digital signal processor can be configured to increase a level of the digital audio signal for frequencies associated emergency vehicles. For example, the digital signal processor can be configured to increase a level of the digital audio signal for frequencies associated with bells, whistles, and sirens.

A transient frequency spectrum of the environment can be determined. The transient frequency spectrum can include an indication of the frequency content of transient or impulse sound that occurs within the environment.

Examples of such transient sound can include gunshots, explosions, bullet impacts, engine noises (such as from motor vehicles and aircraft, for example), and any other comparatively short lived noises.

The transient frequency spectrum of the environment can be used to modify the electronic signal. For example, the transient frequency spectrum of the environment can be used to modify the electronic signal so as to attenuate noise and so as to better facilitate the amplification of information, such as voice communications directed to the user.

According to an embodiment, a method can comprise determining an audiogram, determining a frequency spectrum of an environment, and using the audiogram and the frequency spectrum of the environment to modify an electronic signal to attenuate noise and to amplify information. The frequency spectrum can be an average frequency spectrum over a period of time.

The situation hearing enhancement and protection system can be configured or tuned to provide a specific frequency response that provides both hearing enhancement and hearing protection for a specific user. The situation hearing enhancement and protection system can be configured or tuned to provide a more general frequency response that provides both hearing enhancement and hearing protection for a group of users.

According to an embodiment, the situational hearing enhancement and protection system can comprise a database. The database can contain samples of known noises. The database can contain samples of known noise sound signatures, such as waveforms or Fourier transforms of the noises. The database can be stored in the memory 208. The database can be stored in a memory of a remote computer or server.

Sound signatures from the database can be selected, such as by the user or by a technician. The selected sound signatures can be used by the digital signal processor 202 to characterize the environment and/or to facilitate processing of the digital audio signal so as to attenuate noise contained therein. The occluding earpiece 101 can be in communication, e.g., wireless communication, with the database when the occluding earpiece 101 is in the field so as to facilitate the transfer to sound signatures from the database to the occluding earpiece 101. The occluding earpiece 101 can be placed in communication, e.g., wired communication, with the database when the occluding earpiece 101 is in a shop so as to facilitate the transfer to sound signatures from the database to the occluding earpiece 101.

For example, the database can contain a sample of 9 mm Beretta pistol fire and a sample of AR15 rifle fire. These samples can be the sound signatures or can be used to obtain the sound signatures of 9 mm Beretta pistol fire and AR15 rifle fire. These samples or their associated sound signatures can be communicated to the memory 211 when such noise is expected in the field. Alternatively, these samples or their associated sound signatures can be pre-stored in the memory 211. When noise corresponding to these samples or their associated sound signatures is identified in the environment, and consequently in the digital audio signal, then this noise can be filtered, subtracted, compressed or attenuated from the digital audio signal so as to reduce the level thereof and thus mitigate the user's perception thereof.

According to an embodiment, samples of information can similarly be stored in a database. Such samples can similarly be communicated to the occluding earpiece 101 and used to enhance information in the environment. Thus, the information in the environment, and consequently in the digital audio signal, can be amplified. The information can be filtered, processed, replaced, or otherwise enhanced to make the information better understood by the user.

The earpiece does not have to be an occluding earpiece. The earpiece does not have to be a fully occluding earpiece. Rather than an earpiece, muffs or a headset can be used.

The situation hearing enhancement and protection system can provide multiple frequency band attenuation, compression, and/or amplification. The frequency bands can be preset, determined or determined substantially in real time. The frequency bands can be determined by a technician, determined by the user, determined by the sound environment (and thus be dynamic, situationally-dependent and/or evolving).

The maximum sound level provided to the user's eardrums can be limited. For example, the maximum sound level provided to the user's eardrums can generally be kept to a comfortable or safe level. The output power of the speaker 105 can be limited to keep the sound level at a comfortable or safe level.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected is:

1. A device comprising:
an occluding earpiece;
a memory configured to store an environmental noise signature and an audiogram;
a digital signal processor configured receive a digital audio signal containing environmental noise, to attenuate the environmental noise in the digital audio signal according to the environmental noise signature, to compensate the digital audio signal for hearing loss according to the audiogram, and to provide a digitally processed audio signal; and
a speaker configured to provide audio representative of the digitally processed audio signal.

2. The device of claim 1, further comprising:
a microphone configured to receive ambient sound containing the environmental noise and to provide an analog microphone signal representative thereof;
an analog-to-digital converter configured to receive the analog microphone signal, convert the analog microphone signal into the digital audio signal, and provide the digital audio signal to the digital signal processor;
a digital-to-analog converter configured to receive the digitally processed audio signal and to convert the digitally processed audio signal into a processed analog signal representative of the digitally processed audio signal;
an amplifier configured to receive the processed analog signal, to amplify the processed analog signal, and to provide an amplified analog signal; and
a speaker configured to receive the amplified analog signal and to provide sound representative of the amplified analog signal.

3. The device of claim 2, wherein the memory, the digital signal processor, the microphone, the analog-to-digital converter, the digital-to-analog converter, the amplifier, and the speaker are disposed substantially within the occluding earpiece.

4. The device of claim 1, wherein the digital signal processor is configured perform Fourier analysis on the digital audio signal to facilitate a determination of an environmental noise frequency content thereof.

5. The device of claim 1, wherein the audiogram is for an individual person.

6. The device of claim 1, wherein the audiogram is a general hearing profile for a group of people.

7. The device of claim 1, wherein the digital signal processor is configured to reduce a level of the digital audio signal for frequencies that are present in the environmental noise of the digital audio signal.

8. The device of claim 1, wherein the digital signal processor is configured to increase a level of the digital audio signal for frequencies where hearing loss is present, according to the audiogram.

9. The device of claim 1, further comprising an input port for receiving a signal from a communications system and for providing the signal from the communications system to the digital signal processor.

10. The device of claim 1, further comprising:
an input port for receiving a signal from a communications system and for providing the signal from the communications system to the digital signal processor; and
wherein the digital signal processor is configured to attenuate noise in the signal from the communications system and to modify the signal from the communications system to compensate for hearing loss.

11. The device of claim 1, wherein the digital signal processor is configured to increase a level of the digital audio signal for frequencies that contain non-verbal information.

12. The device of claim 1, wherein the digital signal processor is configured to increase a level of the digital audio signal for frequencies of:
alarms;
bells;
whistles; and
sirens.

13. A method comprising:
determining an audiogram;
determining a frequency spectrum of an environment;
and
using the audiogram and the frequency spectrum of the environment to modify an electronic signal to attenuate noise and to amplify information.

14. The method of claim 13, wherein the frequency spectrum is an average frequency spectrum over a period of time.

15. The method of claim 13, wherein the audiogram is for an individual person.

16. The method of claim 13, wherein the audiogram is for a group of people.

17. The method of claim 13, wherein the audiogram is an average audiogram for a group of people base upon age.

18. The method of claim 13, wherein the audiogram is used to provide human perceived substantially flat hearing.

19. The method of claim 13, wherein the audiogram is used to provide human perceived substantially flat hearing with vocal enhancement.

20. The method of claim 13, wherein the audiogram is used to provide human perceived substantially flat hearing with vocal enhancement and less than 3 dB of high frequency enhancement.

21. The method of claim 13, wherein the audiogram is used to provide human perceived flat hearing with vocal enhancement and more than 3 dB of high frequency enhancement.

22. The method of claim 13, further comprising determining a transient frequency spectrum of the environment and using the transient frequency spectrum of the environment to modify the electronic signal to attenuate noise and to amplify communications.
